(19) United States
(12) Patent Application Publication
(10) Pub. No.: US 2024/0226988 A9
(43) Pub. Date: Jul. 11, 2024

(54) METHOD FOR MANUFACTURING OUTER PANEL

(71) Applicant: TOYOTA JIDOSHA KABUSHIKI KAISHA, Toyota-shi (JP)

(72) Inventors: Satoshi TSUDA, Toyota-shi (JP); Akito TOJO, Toyota-shi (JP); Daichi TAJIMA, Toyota-shi (JP)

(73) Assignee: TOYOTA JIDOSHA KABUSHIKI KAISHA, Toyota-shi (JP)

(21) Appl. No.: 18/467,346

(22) Filed: Sep. 14, 2023

(30) Foreign Application Priority Data
Oct. 24, 2022 (JP) 2022-169897

(51) Int. Cl. B21D 39/02; B23K 26/50

(52) U.S. Cl. CPC B21D 39/021; B23K 26/50

(57) ABSTRACT

To provide a method for manufacturing an outer panel in which takt time is shortened and of high designability. A method for manufacturing an outer panel performing a hemming process according to the present disclosure includes; performing a laser light irradiation process on an inner side of a steel sheet that serves as an outer panel to bend the steel sheet at a first angle, the laser light being irradiated along a ridgeline of a center part of a bend radius of the steel sheet, and performing the hemming process on the steel sheet at a timing that is after the laser irradiation process to bend the steel sheet at a second angle smaller than the first angle.

### CROSS REFERENCE TO RELATED APPLICATIONS

This application is based upon and claims the benefit of priority from Japanese patent application No. 2022-169897, filed on Oct. 24, 2022, the disclosure of which is incorporated herein in its entirety by reference.

### BACKGROUND

The present disclosure relates to a method for manufacturing an outer panel. Japanese Unexamined Patent Application Publication No. H10-225725 discloses that a roller hemming apparatus, in which a robot is made to hold rollers to perform a hemming process, is used for processing vehicle shells, such as vehicle doors and vehicle hoods.

### SUMMARY

Vehicle shells, such as vehicle doors and vehicle hoods, have a bag structure composed of an outer panel on the design side and an inner panel on the driver's side. The outer panel and the inner panel are formed by folding over steel sheets that are used as materials for the respective panels using a press die, and the outer panel has a shape (a flange) having an end bent at a predetermined angle in advance. An integrated assembly is formed by carrying out a process of placing the outer panel over the inner panel (a marriage process) and performing plasticity processing of the flange by fold-back bending the steel sheet (a hemming process).

In addition, processes for manufacturing vehicle parts are strictly controlled and must be finished within the limited takt time. In the manufacturing of vehicle shells, a hemming process is a bottleneck concerning the takt time. This is because if the steel sheet is bent too much at one time in the process of bending a steel sheet, the quality of the steel sheet is deteriorated and so it is necessary to perform the bending process several times.

One possible way to reduce the time taken to perform the hemming process is to reduce the angle of flange of the outer panel in advance, but if the angle of the flange is too small, a problem of the outer panel interfering with the inner panel in the marriage process will occur, as explained below.

FIG. 5A is a schematic diagram of a vehicle 1. FIG. 5B is a schematic cross section of an assembly taken along the dashed line II-II of the vehicle 1 shown in FIG. 5A. An assembly 10 is formed by subjecting an outer panel 20 and an inner panel 30 to a marriage process and a hemming process. In addition, the end of the inner panel 30 is sandwiched by a flange 21 of the outer panel 20.

Here, when the angle θ of the flange 21 is small (see FIG. 5C), the end of the inner panel 30 interferes with the outer panel 20 in the marriage process, resulting in a poor engagement. Therefore, to prevent such an interference, the angle θ of the flange 21 needs to be increased to some extent (see, FIG. 5D).

Thus, in order to manufacture vehicle shells within a limited takt time while satisfying the requirements of both the hemming process and the marriage process, restrictions are imposed on the design.

The present disclosure has been made to solve the problems mentioned above, and an object of the present disclosure is to shorten the length of the takt time and provide a method for manufacturing an outer panel of high designability.

A method for manufacturing an outer panel performing a hemming process according to the present disclosure includes: performing a laser light irradiation process on an inner side of a steel sheet that serves as an outer panel to bend the steel sheet at a first angle, the laser light being irradiated along a ridgeline of a center part of a bend radius of the steel sheet, and performing the hemming process on the steel sheet at a timing that is after the laser irradiation process to bend the steel sheet at a second angle smaller than the first angle. This makes it possible to shorten the takt time whereby restrictions imposed on the design of an outer panel can be reduced, and thus an outer panel of high designability can be manufactured.

The first angle may be 110 degrees or smaller. This makes it possible to improve the quality of the hemming process, whereby designability of the outer panel can be ensured.

The method may further include performing a quenching process on the steel sheet at a timing that is after the laser irradiation process and before the hemming process. This makes it possible to shorten the takt time.

According to the present disclosure, it becomes possible to shorten the length of the takt time and provide a method for manufacturing an outer panel of high designability.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a diagram for describing a method for manufacturing an outer panel according to a first embodiment;

FIG. 2A is a diagram for describing the method for manufacturing an outer panel according to the first embodiment;

FIG. 2B is a diagram for describing the method for manufacturing an outer panel according to the first embodiment;

FIG. 3 is a cross-sectional photograph of an outer panel according to the first embodiment;

FIG. 4 is a diagram for describing a method for manufacturing an outer panel according to a second embodiment;

FIG. 5A is a diagram for describing an interference between an outer panel and an inner panel in a marriage process;

FIG. 5B is a diagram for describing an interference between an outer panel and an inner panel in a marriage process;

FIG. 5C is a diagram for describing an interference between an outer panel and an inner panel in a marriage process; and

FIG. 5D is a diagram for describing an interference between an outer panel and an inner panel in a marriage process.

### DESCRIPTION OF EMBODIMENTS

### First Embodiment

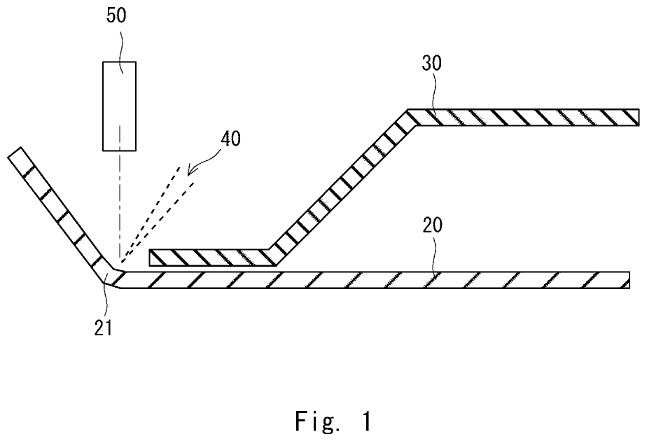

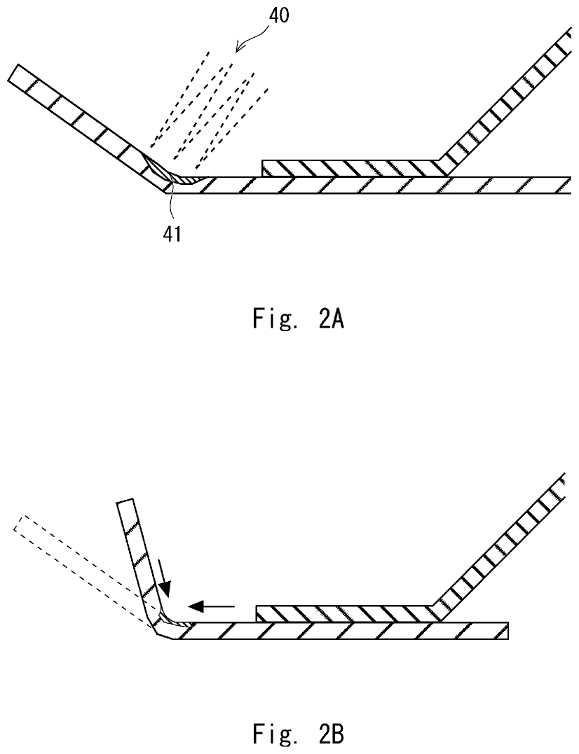

An embodiment of the present disclosure will be described below with reference to the drawings. FIGS. 1 and 2 show a method for manufacturing an outer panel according to the present embodiment.

As shown in FIG. 1, the outer panel 20 according to the present embodiment is provided with a flange 21 having such an angle that interference with the inner panel 30 due to the marriage process does not occur. Now, by irradiating a laser light 40 on the inner side of the steel sheet that serves as the outer panel 20, the steel sheet is bent at a first angle to form the flange 21.

As shown in FIG. 2A, in the laser irradiation process, the laser light 40 is irradiated along the ridgeline of a center part 41 of a bend radius of the steel sheet. By irradiating a laser light onto the steel sheet, the irradiated area and its vicinity are heated to thereby be thermally expanded. Then, as shown in FIG. 2B, the steel sheet shrinks in the direction of the arrow as it returns to a normal temperature. Therefore, bending of the flange according to the present embodiment utilizes plastic deformation using the stress generated due to thermal contraction caused by laser irradiation.

Then, a hemming process is performed in such a way that a second angle of the flange 21 is made smaller than the first angle. The amount of bending in the hemming process is reduced because the bending process is performed through laser irradiation in advance. Therefore, it is possible to reduce the number of times of the bending processes that are performed in multiple batches. In addition, since it is possible to eliminate the bending-over process of the press die, reduction in the manufacturing cost can be expected.

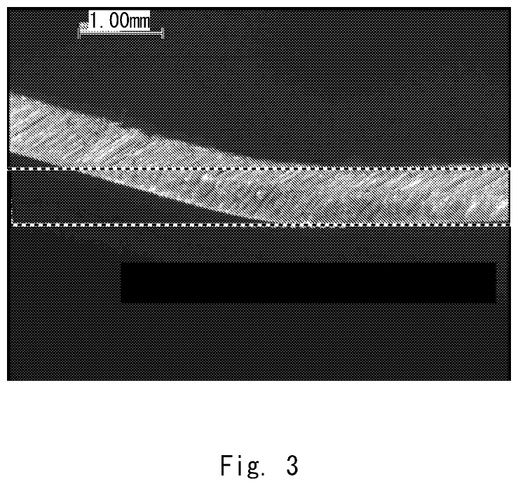

FIG. 3 is a cross-sectional view of a steel sheet that is subjected to a bending process by irradiating a laser light. The flat steel sheet, that is, a steel sheet having a flange formed at an angle of 180 degrees, is bent at about an angle of 30 degrees due to thermal contraction caused by laser irradiation and cooling, so that the angle of flange is about 150 degrees.

When performing a hemming process, if the angle of the flange 21 is greater than 110 degrees, the ridgeline of the flange 21 is blurred and the origin of the bending is hard to see, which compromises designability. Therefore, the first angle is preferably 110 degrees or smaller. As a result, the quality of the hemming process is improved, and it is possible to ensure designability of the outer panel.

A quenching process may be performed on the steel sheet at a timing that is before the hemming process. By performing the quenching process, the stress generated due to thermal contraction becomes large, and therefore the angle of the flange can be made small, whereby it is possible to shorten the takt time. An example of the cooling mechanism includes an air blow.

In the laser irradiation process, the amount of irradiation of the laser light 40 may be controlled by monitoring the laser heat with a temperature sensor 50. In addition, a laser torch (not shown) for emitting a laser light has a spring-type guide mechanism and may be configured to always irradiate the center of the bend radius of the steel sheet with the laser light.

In carrying out the aforementioned method for manufacturing an outer panel, the mechanism for performing a laser irradiation process and the mechanism for performing a hemming process may be arranged in the same processing line. With such a configuration, the laser irradiation process and the hemming process can be conducted simultaneously or continuously, which enables space saving and high-speed production.

In this way, it becomes possible to shorten the length of the takt time and provide a method for manufacturing an outer panel of high designability.

### Second Embodiment

The present embodiment describes how to efficiently perform bending of a steel sheet using a core bar in a hemming process performed at a timing that is after the laser irradiation process. It should be noted that the same components as those in the first embodiment are denoted by the same reference symbols, and redundant descriptions thereof are omitted.

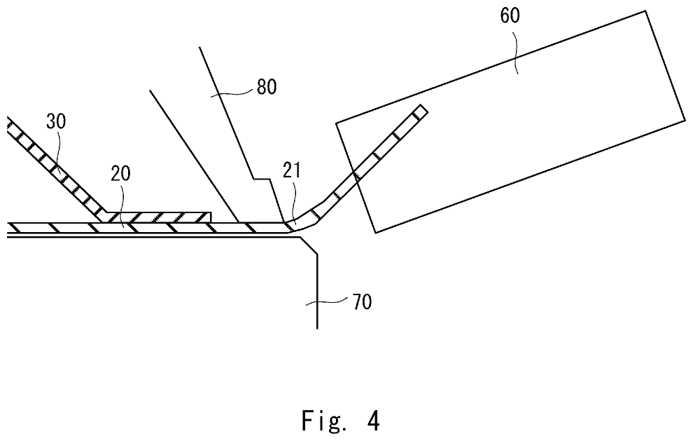

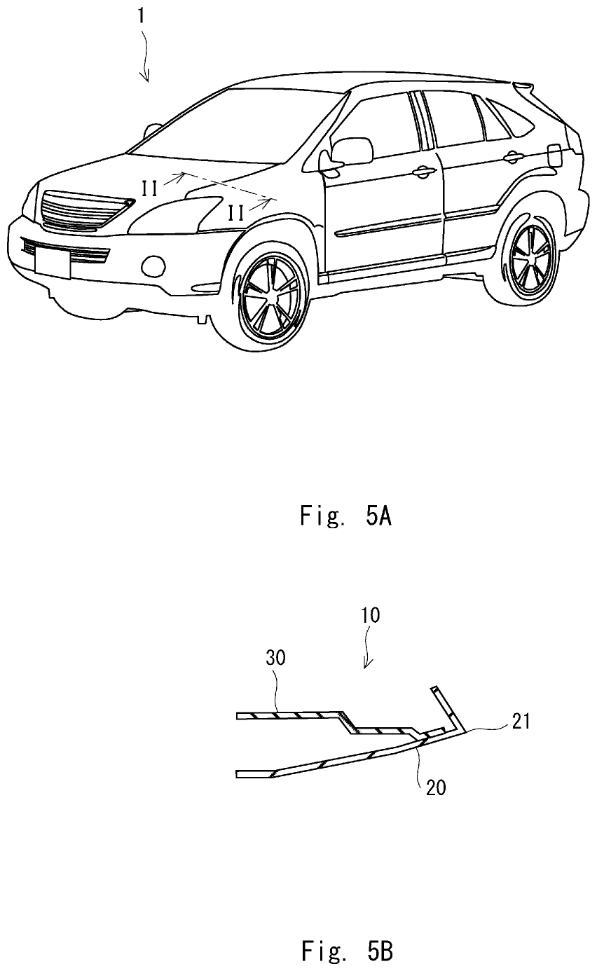

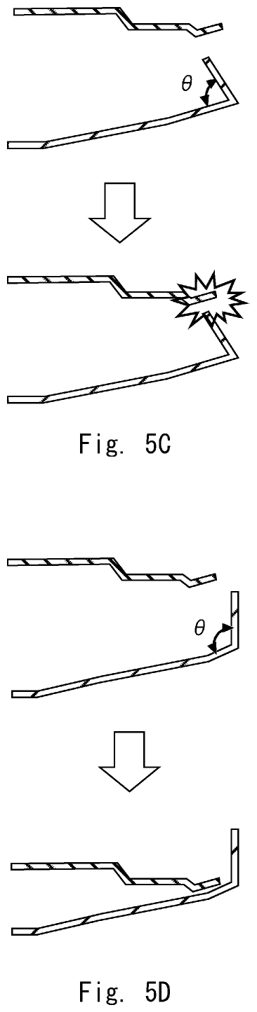

FIG. 4 shows a method for manufacturing an outer panel according to the present embodiment. A core bar 80 is placed in the vicinity of the flange 21 of a steel sheet, which serves as the outer panel 20 and which has been subjected to the marriage process with the inner panel 30, and the outer panel 20 is held by the core bar 80 and a die 70. Then, the steel sheet is hemmed using a roller 60.

By pressing the outer panel 20 with the core bar 80 and the die 70, an area where stress concentrates can be created, thus facilitating the bending process with the roller 60. This makes it possible to shorten the takt time.

In this way, it becomes possible to shorten the takt time and provide a method for manufacturing an outer panel of high designability.

It should be noted that the present disclosure is not limited to the aforementioned embodiments and can be changed as appropriate without departing from the gist of the present disclosure. For example, the present disclosure describes a manufacturing method that includes performing a hemming process, but it is not limited thereto, and the manufacturing method according to the present disclosure can be applied to the same type of processing method.

From the disclosure thus described, it will be obvious that the embodiments of the disclosure may be varied in many ways. Such variations are not to be regarded as a departure from the spirit and scope of the present disclosure, and all such modifications as would be obvious to one skilled in the art are intended for inclusion within the scope of the following claims.

What is claimed is:

1. A method for manufacturing an outer panel performing a hemming process comprising:
performing a laser light irradiation process on an inner side of a steel sheet that serves as an outer panel to bend the steel sheet at a first angle, the laser light being irradiated along a ridgeline of a center part of a bend radius of the steel sheet, and
performing the hemming process on the steel sheet at a timing that is after the laser irradiation process to bend the steel sheet at a second angle smaller than the first angle.

2. The method according to claim 1, wherein the first angle is 110 degrees or smaller.

3. The method according to claim 1, further comprising performing a quenching process on the steel sheet at a timing that is after the laser irradiation process and before the hemming process.
